(19) United States
(12) Patent Application Publication
(10) Pub. No.: US 2026/0342968 A1
(43) Pub. Date: Oct. 29, 2026

(54) FLEXIBLE GRADUAL DECODING REFRESH

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 19/268,083

(22) PCT Filed: Jan. 12, 2024
(86) PCT No.: PCT/IB2024/050339

§ 371 Date: Jul. 14, 2025

Related U.S. Application Data
(60) Provisional application No. 63/480,085, filed on Jan. 16, 2023.

(51) Int. Cl. H04N 19/107; H04N 19/167; H04N 19/172; H04N 19/70

(52) U.S. Cl. CPC H04N 19/107; H04N 19/167; H04N 19/172; H04N 19/70

(57) ABSTRACT

Various embodiments provide an apparatus, a method, and a computer program product. An example apparatus includes: at least one processor; and at least one memory storing instructions that, when executed by the at least one processor, cause the apparatus at least to perform: using a general gradual decoding refresh (GDR) technique, in which a refreshed area starts at any location in a gradual decoding refresh (GDR) picture and gradually expands over associated recovering picture.

### TECHNICAL FIELD

The teachings in accordance with the exemplary embodiments of this invention relate generally to video coding, more specifically, relate to gradual decoding refresh.

### BACKGROUND

It is known to perform video coding.

### SUMMARY

Example 1. A method comprising: using a general gradual decoding refresh (GDR) technique, in which a refreshed area starts at any location in a gradual decoding refresh (GDR) picture and gradually expands over associated recovering picture. In an embodiment, the general GDR technique is used for a low-latency video.

Example 2. The method of example 1 further comprising: determining an area in a gradual decoding refresh (GDR) or recovering (GDR/recovering) picture; defining one or more virtual boundaries for the GDR/recovering picture, wherein the one or more virtual boundaries separate the GDR/recovering picture into two or more areas; associating an indication message or information with each of the one or more virtual boundaries, wherein the indication message or information specifies at least one of which side of the associated virtual boundary is in a refreshed area or which side in a non-refreshed area; and encoding and signaling the indication message or information to a decoder. An example of the indication message or information, include but is not limited to, a flag.

Example 3. A method comprising: receiving a gradual decoding refresh (GDR) or recovering (GDR/recovering) picture, wherein a refreshed area starts at any location in the gradual decoding refresh (GDR) picture and expands over the recovering picture.

Example 4. The method of example 3, wherein the GDR/recovering picture comprises one or more virtual boundaries, wherein the one or more virtual boundaries separate the GDR/recovering picture into two or more areas, and wherein the method further comprises; receiving an indication message or information associated with each of the one or more virtual boundaries, wherein the indication message or information specifies at least one of which side of each of the one or more virtual boundaries is in refreshed area or which side is in a non-refreshed area; and decoding the GDR/recovering picture based on the one or more virtual boundaries and associated indication message or information. An example of the indication message or information, include but is not limited to, a flag.

Example 5. The method of any of the previous examples, wherein when the indication message or information is equal to 1 specifies position or location of the refreshed area with respect to the virtual boundary associated with the indication message or information.

Example 6. The method of any of the previous examples, wherein when the indication message or information is equal to 0 specifies position or location of a non-refreshed area with respect to the virtual boundary associated with the indication message or information.

Example 7. The method of any of the previous examples, wherein the one or more virtual boundaries comprise one or more vertical virtual boundaries and/or one or more horizontal virtual boundaries.

Example 8. The method of example 7, wherein when the indication message or information is equal to 1 and is associated with a vertical virtual boundary, the indication message or information specifies that the area on left of the vertical virtual boundary is the refreshed area and the area on the right of the vertical virtual boundary is the non-refreshed area.

Example 9. The method of example 7, wherein when the indication message or information is equal to 1 and is associated with a horizontal virtual boundary, the indication message or information specifies that the area above the horizontal virtual boundary is the refreshed area and the area below the horizontal virtual boundary is the non-refreshed area.

Example 10. The method of example 7, wherein when the indication message or information is equal to 0 and is associated with a vertical virtual boundary, the indication message or information specifies that the area on left of the vertical virtual boundary is the non-refreshed area and the area on right of the vertical virtual boundary is the refreshed area.

Example 11. The method of example 7, wherein when the indication message or information is equal to 0 and is associated with a horizontal virtual boundary, the indication message or information specifies that the area above the horizontal virtual boundary is the non-refreshed area and the area below the horizontal virtual boundary is the refreshed area.

Example 12. An apparatus comprising: at least one processor; and at least one memory storing instructions that, when executed by the at least one processor, cause the apparatus at least to perform: using a general gradual decoding refresh (GDR) technique, in which a refreshed area starts at any location in a gradual decoding refresh (GDR) picture and gradually expands over associated recovering picture. In an embodiment, the general GDR technique is used for a low-latency video.

Example 13. The apparatus of example 12, wherein the apparatus is further caused to perform: determining an area in a gradual decoding refresh (GDR) or recovering (GDR/recovering) picture; defining one or more virtual boundaries for the GDR/recovering picture, wherein the one or more virtual boundaries separate the GDR/recovering picture into two or more areas; associating an indication message or information with each of the one or more virtual boundaries, wherein the indication message or information specifies at least one of which side of the associated virtual boundary is in a refreshed area or which side in a non-refreshed area; and encoding and signaling the indication message or information to a decoder.

Example 14. An apparatus comprising: at least one processor; and at least one memory storing instructions that, when executed by the at least one processor, cause the apparatus at least to perform: receiving a gradual decoding refresh (GDR) or recovering (GDR/recovering) picture, wherein a refreshed area starts at any location in the gradual decoding refresh (GDR) picture and expands over the recovering picture.

Example 15. The apparatus of example 14, wherein the GDR/recovering picture comprises one or more virtual boundaries, wherein the one or more virtual boundaries separate the GDR/recovering picture into two or more areas, wherein the apparatus is further caused to perform; receiving an indication message or information associated with each of the one or more virtual boundaries, wherein the indication message or information specifies at least one of which side of each of the one or more virtual boundaries is in the refreshed area or which side is in a non-refreshed area; and decoding the GDR/recovering picture based on the one or more virtual boundaries and associated indication message or information.

Example 16. The apparatus of any of the previous examples, wherein when the indication message or information is equal to 1 specifies position or location of the refreshed area with respect to the virtual boundary associated with the indication message or information.

Example 17. The apparatus of any of the previous examples, wherein when the indication message or information is equal to 0 specifies position or location of a non-refreshed area with respect to the virtual boundary associated with the indication message or information.

Example 18. The apparatus of any of the previous examples, wherein the one or more virtual boundaries comprise one or more vertical virtual boundaries and/or one or more horizontal virtual boundaries.

Example 19. The apparatus of example 14, wherein when the indication message or information is equal to 1 and is associated with a vertical virtual boundary, the indication message or information specifies that the area on left of the vertical virtual boundary is the refreshed area and the area on the right of the vertical virtual boundary is the non-refreshed area.

Example 20. The apparatus of example 14, wherein when the indication message or information is equal to 1 and is associated with a horizontal virtual boundary, the indication message or information specifies that the area above the horizontal virtual boundary is the refreshed area and the area below the horizontal virtual boundary is the non-refreshed area.

Example 21. The apparatus of example 14, wherein when the indication message or information is equal to 0 and is associated with a vertical virtual boundary, the indication message or information specifies that the area on left of the vertical virtual boundary is the non-refreshed area and the area on right of the vertical virtual boundary is the refreshed area.

Example 22. The apparatus of example 14, wherein when the indication message or information is equal to 0 and is associated with a horizontal virtual boundary, the indication message or information specifies that the area above the horizontal virtual boundary is the non-refreshed area and the area below the horizontal virtual boundary is the refreshed area.

Example 23. A computer-readable medium encoded with instructions that, when executed by a computer, causing an apparatus to perform methods as described in any of the examples 1 to 11.

Example 24. The computer-readable medium of example 23, wherein the computer-readable medium comprises a non-transitory computer-readable medium.

Example 25. An apparatus comprising means for performing the methods as described in any of the examples 1 to 11.

Certain abbreviations that may be found in the description and/or in the Figures are herewith defined as follows:

| | |
|---|---|
| GDR | gradual decoding refresh |
| ECM | enhanced compression model |
| JVET | joint video experts team |
| IRAP | intra random access point |
| POC | picture order count |
| VVC | versatile video coding |

### BRIEF DESCRIPTION OF THE DRAWINGS

The above and other features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates the basic concept of vertical GDR, where a refreshed area starts from left of a gradual decoding refresh (GDR) picture;

FIGS. 2a and 2b show two possible examples of a GDR picture; where in FIG. 2a, a refreshed area starts in the middle of a GDR picture and expands to the left and the right of associated recovering pictures, and in FIG. 2b, a refreshed area starts in the center of a GDR picture and expands in all the four directions of associated recovering pictures,

FIG. 3 shows an example picture header syntax structure, in accordance with an embodiment;

FIG. 4 shows an example, in which a central area is refreshed, in accordance with an embodiment;

FIG. 5 shows an example of proposed syntax changes in a picture header structure syntax, in accordance with an embodiment;

FIG. 6 is an example apparatus, which may be implemented in hardware, and caused to implement the examples described herein;

FIG. 7 shows a schematic representation of non-volatile memory media;

FIG. 8 is an example method to implement the examples described herein, in accordance with an embodiment;

FIG. 9 is an example method to implement the examples described herein, in accordance with another embodiment; and

FIG. 10 is an example method to implement the examples described herein, in accordance with yet another embodiment;

FIG. 11 is an example method to implement the examples described herein, in accordance with still another embodiment; and

FIG. 12 shows a block diagram of one possible and non-limiting exemplary system in which the exemplary embodiments may be practiced.

### DETAILED DESCRIPTION

In example embodiments, there is proposed at least a gradual decoding refresh (GDR) technique, in which a refreshed area may start at any location in a GDR picture and gradually expand over associated recovering pictures. Also proposed are method and apparatus to implement the proposed GDR.

A coded video sequence may include intra coded pictures (e.g., I picture) and inter coded pictures (e.g., P and B pictures). Intra coded pictures usually use many more bits than inter coded pictures. Transmission time of such intra coded pictures increases the encoder to decoder delay. For (ultra) low-delay applications, it is desirable that all the coded pictures have similar number of bits so that the encoder to decoder delay may be reduced to around 1 picture interval. Hence, intra coded picture may not be a fit for (ultra) low-delay applications. However, on the other hand, an intra coded picture is indeed needed at random access point.

Gradual decoding refresh (GDR) approaches alleviate the delay issue with intra coded pictures. Instead of coding an intra picture at a random access point, GDR progressively refreshes pictures over several pictures.

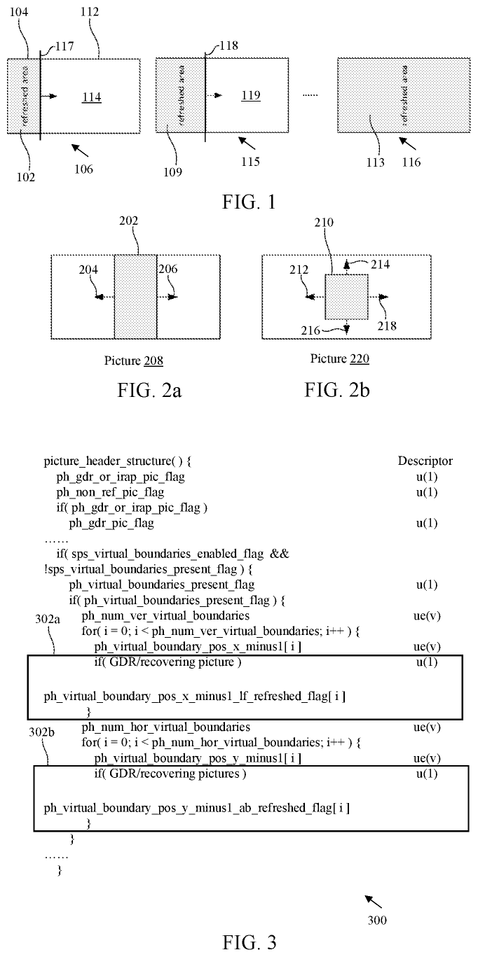

FIG. 1 illustrates the basic concept of vertical GDR, where a refreshed area starts from the left of a picture and gradually expands over a few following pictures. The first picture is a GDR picture 106 and the last picture is a recovery point picture 116. Pictures between a GDR picture and its recovery point picture are called associated recovering pictures, for example, recovering picture 115. As shown in FIG. 1, in some versatile video coding (VVC)/enhanced compression model (ECM) software implementations, GDR starts with a refreshed area 102 at a left side 104 of the GDR picture 106, and then gradually expands the refreshed area 102 (e.g., expanded refreshed area 109 and 113) to the right of the associated recovering picture(s) 115. A virtual boundary included in picture header is used to separate refreshed area and non-refreshed area of a GDR/recovering picture. For example, in FIG. 1, a virtual boundary 117 is used to separate refreshed area 102 and non-refreshed area 114 of the GDR picture 106, and a virtual boundary 118 is used to separate refreshed area 108 and non-refreshed area 119 of the recovering picture 115.

However, it has been observed that most of gaming sequences and many nature sequences have their main characters and activities in the middle of pictures. Therefore, it makes sense to have a refreshed area starting in the middle of a GDR picture and gradually expanding over the associated recovering pictures. FIGS. 2a and 2b show two possible examples of GDR. In example shown in FIG. 2a, the refreshed area 202 starts in the middle of a picture 208 and then expands to the left 204 and the right 206 of future picture(s). In the example shown in FIG. 2b, a refreshed area 210 starts in the center of a picture 220 and then expands in all four directions 212, 214, 216, and 218 in future picture(s).

Various embodiments propose a more general GDR, where a refreshed area may start in anywhere or any location of a GDR picture and gradually expand over associated recovering picture(s).

With this more general GDR, all existing coding modes in VVC/ECM may still be performed as it is.

To support such more general GDR, multiple virtual boundaries may be required. These multiple virtual boundaries may separate a GDR/recovering picture into a few areas. Further, a decoder needs to know which area separated by virtual boundaries is refreshed area of a GDR/recovering picture. It is therefore further proposed that for GDR/recovering pictures, a flag associated with each virtual boundary is signaled. The flag may specify which side of a virtual boundary is in refreshed area. For example, a flag equal to 1 for a vertical/horizontal virtual boundary may specify the left/above of the vertical/horizontal virtual boundary is in refreshed area, while a flag equal to 0 for a vertical/horizontal virtual boundary may specify the left/above of the vertical/horizontal virtual boundary is in non-refreshed area. Virtual boundaries may be used to determine whether an area is a refreshed area, or not, in a GDR/recovering picture.

In an addition embodiment, it is proposed that picture boundaries may not be used to determine whether an area is a refreshed area, or not, in a GDR/recovering picture.

A refreshed area of a GDR/recovering picture may be an area that has all the flags associated with its surrounded virtual boundaries indicate it is ‘in refreshed area’.

When an area is surrounded by both virtual boundaries and picture boundaries, the flags associated with its virtual boundaries are used to determine whether the area is a refreshed area or not, and picture boundaries are not taken into consideration.

FIG. 3 shows an example picture header syntax structure 300, in accordance with an embodiment. FIG. 3 shows example proposed syntax changes 302a, 302b in picture header of VVC. The proposed picture header syntax structure 300 is conditionally added for each virtual boundary.

In an example, ph_virtual_boundary_pos_x_minus1_lf_refreshed_flag[i] equal to 1 specifies that the area on the left and the right of the i-th vertical virtual boundary specified by ph_virtual_boundary_pos_x_minus1[i] is in refreshed area and non-refreshed area, respectively. ph_virtual_boundary_pos_x_minus1_lf_refreshed_flag[i] equal to 0 specifies that the left and the right of the i-th vertical virtual boundary specified by ph_virtual_boundary_pos_x_minus1[i] is in non-refreshed area and refreshed area, respectively. In another example, ph_virtual_boundary_pos_x_minus1_lf_refreshed_flag[i] equal to 0 specifies that the area on the left and the right of the i-th vertical virtual boundary specified by ph_virtual_boundary_pos_x_minus1[i] is in refreshed area and non-refreshed area, respectively. ph_virtual_boundary_pos_x_minus1_lf_refreshed_flag[i] equal to 1 specifies that the left and the right of the i-th vertical virtual boundary specified by ph_virtual_boundary_pos_x_minus1[i] is in non-refreshed area and refreshed area, respectively.

In an example, ph_virtual_boundary_pos_y_minus1_ab_refreshed_flag[i] equal to 1 specifies that the area above and below the i-th horizontal virtual boundary specified by ph_virtual_boundary_pos_y_minus1[i] is in refreshed area and non-refreshed area, respectively. ph_virtual_boundary_pos_y_minus1_ab_refreshed_flag[i] equal to 0 specifies that the area above and below the i-th horizontal virtual boundary specified by ph_virtual_boundary_pos_y_minus1[i] is in non-refreshed area and refreshed area, respectively. In another example, ph_virtual_boundary_pos_y_minus1_ab_refreshed_flag[i] equal to 0 specifies that the area above and below the i-th horizontal virtual boundary specified by ph_virtual_boundary_pos_y_minus1[i] is in refreshed area and non-refreshed area, respectively. ph_virtual_boundary_pos_y_minus1_ab_refreshed_flag[i] equal to 1 specifies that the area above and below the i-th horizontal virtual boundary specified by ph_virtual_boundary_pos_y_minus1[i] is in non-refreshed area and refreshed area, respectively.

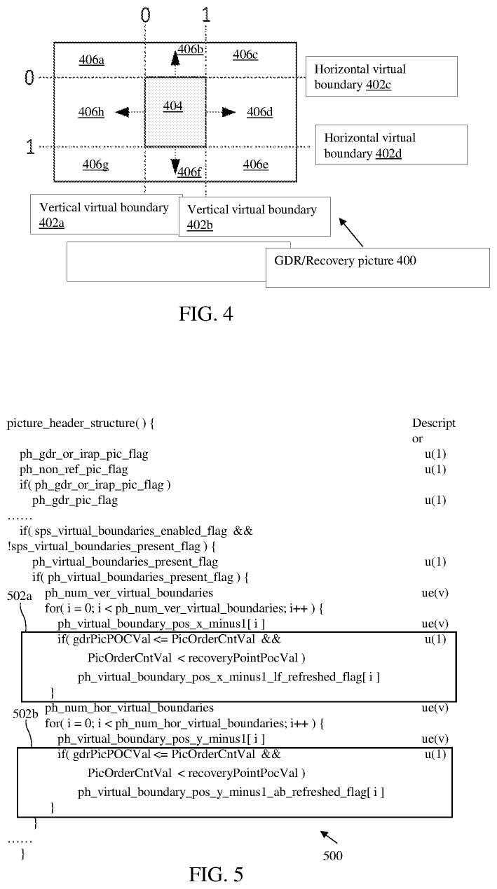

FIG. 4 shows an example, in which a central area 402 is refreshed, in accordance with an embodiment. The central area 402, surrounded by four virtual boundaries (VBs) 402a, 402b, 402c, and 402d, is the refreshed area of a GDR/recovering picture 300. In this example, there are two virtual vertical boundaries 402a, 402b; and two virtual horizontal boundaries 402c, 402d. The virtual vertical boundary 402a has its associated flag ph_virtual_boundary_pos_x_minus1_lf_refreshed_flag[0] equal to 0, and the virtual vertical boundary 402b has its associated flag ph_virtual_boundary_pos_x_minus1_lf_refreshed_flag[1] equal to 1. Accordingly, an area on the right side of the virtual vertical boundary 402a is the refreshed area 404, which is on the left side of the virtual vertical boundary 402b. The virtual horizontal boundary 402c has its associated flag ph_virtual_boundary_pos_y_minus1_ab_refreshed_flag[0] equal to 0 and the virtual horizontal boundary 402d has its associated flag ph_virtual_boundary_pos_y_minus1_ab_refreshed_flag[1] equal to 1. Accordingly, an area below the virtual horizontal boundary 402c is the refreshed area 404, which is above the virtual horizontal boundary 402d. As seen, the flags associated with all the four virtual boundaries 402a, 402b, 402c, and 402d, indicate that the refreshed area 404 is comprised in a central area.

All the other areas in FIG. 4 have at least one flag associated with their virtual boundaries to indicate they are in a non-refreshed area 406a, 406b, 406c, 406d, 406e, 406f, 406g and 406h. Accordingly, these areas in FIG. 4 are in non-refreshed areas.

In the above example, the proposed picture header syntax structure (e.g., the picture header syntax structure 300) per virtual boundary is conditionally applied to GDR/recovering pictures. In an example, each virtual boundary is associated with a flag of 0 or 1 indicting which side of the virtual boundary is in refreshed area.

A GDR/recovering picture may be determined using syntax in a picture header of VVC. FIG. 5 shows an example of proposed syntax changes 502a, 502b in a picture header structure syntax 500, in accordance with an embodiment.

PicOrderCntVal is a picture order count (POC) of a current picture.

ph_recovery_poc_cnt specifies a recovery point of decoded pictures in output order. When the current picture is a GDR picture, the variables gdrPicPocVal and recoveryPointPocVal are derived as follows:
gdrPicPOCVal=PicOrderCntVal
recoveryPointPocVal=PicOrderCntVal+ph_recovery_poc_cnt

When the current picture is a GDR picture and ph_recovery_poc_cnt is equal to 0, the current picture is also referred to as the recovery point picture. Otherwise, when the current picture is a GDR picture, and there is a picture picA that follows the current GDR picture in decoding order in the CLVS that has PicOrderCntVal equal to recoveryPointPocVal, the picture picA is referred to as the recovery point picture; otherwise, the first picture in output order that has PicOrderCntVal greater than recoveryPointPocVal in the CLVS is referred to as the recovery point picture. The recovery point picture may not precede the current GDR picture in decoding order. The pictures that are associated with the current GDR picture and have PicOrderCntVal less than recoveryPointPocVal are referred to as the recovering pictures of the GDR picture. The value of ph_recovery_poc_cnt may be in a range of 0 to MaxPicOrderCntLsb−1, inclusive.

When a sps_gdr_enabled_flag is equal to 1 and PicOrderCntVal of the current picture is greater than or equal to recoveryPointPocVal of the associated GDR picture, the current and subsequent decoded pictures in output order are exact match to the corresponding pictures produced by starting the decoding process from the previous intra random access point (IRAP) picture, when present, preceding the associated GDR picture in decoding order.

FIG. 6 is an example apparatus 600, which may be implemented in hardware, and caused to implement the examples described herein. The apparatus 600 comprises at least one processor 602, at least one non-transitory memory 604 including computer program code 605, wherein the at least one memory 604 and the computer program code 605 are configured to, with the at least one processor 602, cause the apparatus 600 to implement a gradual decoding refresh technique 606, in which a refresh area starts at any location of a GDR/recovering picture and gradually expands over associated recovering pictures, based on the examples described herein.

The apparatus 600 optionally includes a display 608 that may be used to display content during rendering. The apparatus 600 optionally includes one or more network (NW) interfaces (I/F(s)) 610. The NW I/F(s) 610 may be wired and/or wireless and communicate over the Internet/other network(s) via any communication technique. The NW I/F(s) 610 may comprise one or more transmitters and one or more receivers. The N/W I/F(s) 610 may comprise standard well-known components such as an amplifier, filter, frequency-converter, (de)modulator, and encoder/decoder circuitry(ies) and one or more antennas.

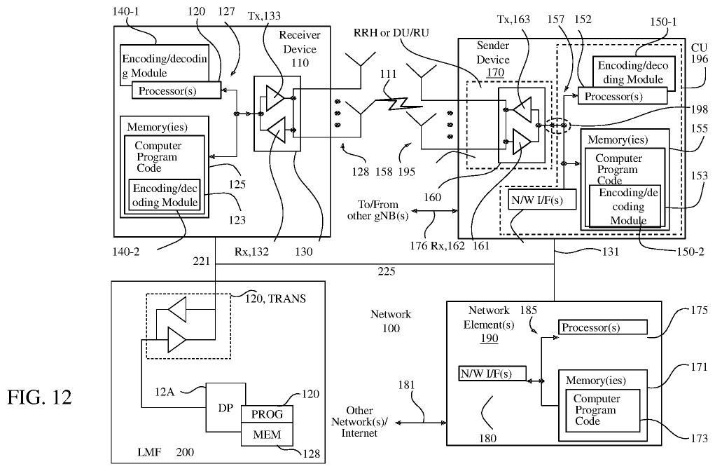

The apparatus 600 may be a remote, virtual or cloud apparatus. The apparatus 600 may be either a coder or a decoder, or both a coder and a decoder. The at least one memory 604 may be implemented using any suitable data storage technology, such as semiconductor based memory devices, flash memory, magnetic memory devices and systems, optical memory devices and systems, fixed memory and removable memory. The at least one memory 604 may comprise a database for storing data. The apparatus 600 need not comprise each of the features mentioned, or may comprise other features as well. The apparatus 600 may correspond to or be another embodiment for example, apparatuses shown in FIG. 12, including a receiver device 110, a sender device 170, or a network element(s) 190.

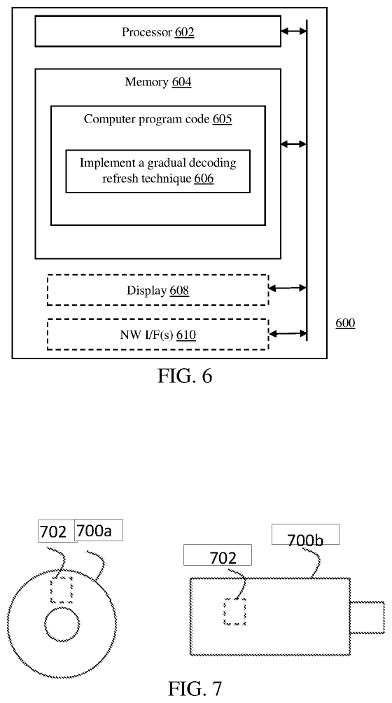

FIG. 7 shows a schematic representation of non-volatile memory media 700a (e.g., computer/compact disc (CD) or digital versatile disc (DVD)) and 700b (e.g., universal serial bus (USB) memory stick) storing instructions and/or parameters 702 which when executed by a processor allows the processor to perform one or more of the steps of the methods described herein.

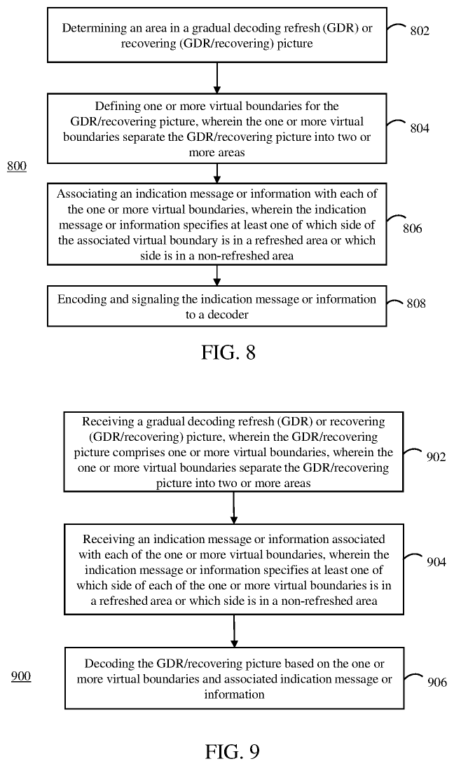

FIG. 8 is an example method 800 to implement the examples described herein, in accordance with an embodiment. At 802, the method 800 includes determining an area in a gradual decoding refresh (GDR) or recovering (GDR/recovering) picture. At 804, the method 800 includes defining one or more virtual boundaries for the GDR/recovering picture, wherein the one or more virtual boundaries separate the GDR/recovering picture into two or more areas. At 806, the method 800 includes associating a flag with each of the one or more virtual boundaries, wherein the flag specifies at least one of which side of the associated virtual boundary is in a refreshed area and which side in a non-refreshed area. At 808, the method 800 includes encoding and signaling the flag to a decoder. An example of the indication message or information, include but is not limited to, a flag.

The method 800 may be performed with an apparatus described herein, for example, the apparatus 600.

FIG. 9 is an example method 900 to implement the examples described herein, in accordance with another embodiment. At 902, the method 900 includes receiving a gradual decoding refresh (GDR) or recovering (GDR/recovering) picture, wherein the GDR/recovering picture comprises one or more virtual boundaries, wherein the one or more virtual boundaries separate the GDR/recovering picture into two or more areas. At 904, the method 900 includes receiving a flag associated with each of the one or more virtual boundaries, wherein the flag specifies at least one of which side of each of the one or more virtual boundaries is in a refreshed area or which side is in a non-refreshed area. At 906, the method 900 includes decoding the GDR/recovering picture based on the one or more virtual boundaries and associated flags. An example of the indication message or information, include but is not limited to, a flag.

The method 900 may be performed with an apparatus described herein, for example, the apparatus 600.

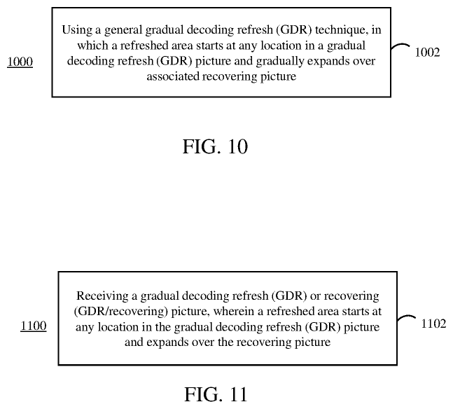

FIG. 10 is an example method 1000 to implement the examples described herein, in accordance with yet another embodiment. At 1002, the method 1000 includes using a general gradual decoding refresh (GDR) technique, in which a refreshed area starts at any location in a gradual decoding refresh (GDR) picture and gradually expands over associated recovering picture. In an embodiment, the method may further include further comprising: determining an area in a gradual decoding refresh (GDR) or recovering (GDR/recovering) picture; defining one or more virtual boundaries for the GDR/recovering picture, wherein the one or more virtual boundaries separate the GDR/recovering picture into two or more areas; associating an indication message or information with each of the one or more virtual boundaries, wherein the indication message or information specifies at least one of which side of the associated virtual boundary is in a refreshed area or which side in a non-refreshed area; and encoding and signaling the indication message or information to a decoder. An example of the indication message or information, include but is not limited to, a flag. In an embodiment, the general GDR technique is used for a low-latency video.

The method 1000 may be performed with an apparatus described herein, for example, the apparatus 600.

FIG. 11 is an example method 1100 to implement the examples described herein, in accordance with still another embodiment. At 1102, the method 1100 includes receiving a gradual decoding refresh (GDR) or recovering (GDR/recovering) picture, wherein a refreshed area starts at any location in the gradual decoding refresh (GDR) picture and expands over the recovering picture. In an embodiment, wherein the GDR/recovering picture comprises one or more virtual boundaries, wherein the one or more virtual boundaries separate the GDR/recovering picture into two or more areas, and wherein the method further comprises; receiving an indication message or information associated with each of the one or more virtual boundaries, wherein the indication message or information specifies at least one of which side of each of the one or more virtual boundaries is in refreshed area or which side is in a non-refreshed area; and decoding the GDR/recovering picture based on the one or more virtual boundaries and associated indication message or information. An example of the indication message or information, include but is not limited to, a flag.

The method 1100 may be performed with an apparatus described herein, for example, the apparatus 600.

FIG. 12 shows a block diagram of one possible and non-limiting exemplary system in which the exemplary embodiments may be practiced. As shown in FIG. 12, a receiver device 110 is in wireless communication with a wireless network 100. A UE is a wireless, typically mobile device that can access a wireless network. The receiver device 110 includes one or more processors 120, one or more memories 125, and one or more transceivers 130 interconnected through one or more buses 127. Each of the one or more transceivers 130 includes a receiver Rx, 132 and a transmitter Tx 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The receiver device 110 may include an encoding and/or decoding module 140 which is configured to perform the example embodiments of the invention as described herein. The encoding and/or decoding module 140-1 or 140-2 may be implemented in hardware by itself of as part of the processors and/or the computer program code of the receiver device 110. encoding and/or decoding module 140 comprising one of or both parts 140-1 and/or 140-2, which may be implemented in a number of ways. encoding and/or decoding module 140 may be implemented in hardware as encoding and/or decoding module 140-1, such as being implemented as part of the one or more processors 120. The encoding and/or decoding module 140-1 may be implemented also as an integrated circuit or through other hardware such as a programmable gate array. In another example, the encoding and/or decoding module 140 may be implemented as encoding and/or decoding module 140-2, which is implemented as computer program code 123 and is executed by the one or more processors 120. Further, it is noted that the encoding and/or decoding modules 140-1 and/or 140-2 are optional. For instance, the one or more memories 125 and the computer program code 123 may be configured, with the one or more processors 120, to cause the user equipment 110 to perform one or more of the operations as described herein. The receiver device 110 communicates with sender device 170 via a wireless link 111 and the LMF 200 via link 221.

The sender device 170 (NR/5G Network device e.g., for LTE, long term evolution) that provides access by wireless devices such as the receiver device 110 to the wireless network 100. The sender device 170 includes one or more processors 152, one or more memories 155, one or more network interfaces (N/W I/F(s)) 161, and one or more transceivers 160 interconnected through one or more buses 157. Each of the one or more transceivers 160 includes a receiver Rx 162 and a transmitter Tx 163. The one or more transceivers 160 are connected to one or more antennas 158. The one or more memories 155 include computer program code 153. The sender device 170 includes encoding and/or decoding module 150 which is configured to perform example embodiments of the invention as described herein. The encoding and/or decoding module 150 may comprise one of or both parts 150-1 and/or 150-2, which may be implemented in a number of ways. The encoding and/or decoding module 150 may be implemented in hardware by itself or as part of the processors and/or the computer program code of the sender device 170. The encoding and/or decoding module 150-1, such as being implemented as part of the one or more processors 152. The encoding and/or decoding module 150-1 may be implemented also as an integrated circuit or through other hardware such as a programmable gate array. In another example, the encoding and/or decoding module 150 may be implemented as the encoding and/or decoding module 150-2, which is implemented as computer program code 153 and is executed by the one or more processors 152. Further, it is noted that the encoding and/or decoding modules 150-1 and/or 150-2 are optional. For instance, the one or more memories 155 and the computer program code 153 may be configured to cause, with the one or more processors 152, the sender device 170 to perform one or more of the operations as described herein. The one or more network interfaces 161 communicate over a network such as via the links 176, 221, and 131. Two or more sender device 170 may communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the sender device 170 being physically in a different location from the RRH, and the one or more buses 157 could be implemented in part as fiber optic cable to connect the other elements of the sender device 170 to the RRH 195.

It is noted that description herein indicates that “cells” perform functions, but it should be clear that the gNB that forms the cell will perform the functions. The cell makes up part of a gNB. That is, there can be multiple cells per gNB.

The wireless network 100 may include a NCE/MME/SGW/UDM/PCF/AMM/SMF 190, which can comprise a network control element (NCE), and/or serving gateway (SGW) 190, and/or MME (Mobility Management Entity) and/or SGW (Serving Gateway) functionality, and/or user data management functionality (UDM), and/or PCF (Policy Control) functionality, and/or Access and Mobility Management (AMM) functionality, and/or Session Management (SMF) functionality, and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF 190 is configurable to perform operations in accordance with example embodiments of the invention in any of an LTE, NR, 5G and/or any standards based communication technologies being performed or discussed at the time of this application.

The sender device 170 is coupled via a link 131 to the NCE/MME/SGW 190 and via link 131 and link 225 to the LMF 200. The link 131 or link 225 may be implemented as, e.g., an S1 interface. The NCE/MME/SGW 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE/MME/SGW 190 to perform one or more operations. In addition, the NCE/MME/SGW 190, as are the other devices, is equipped to perform operations of such as by controlling the receiver device 110 and/or sender device 170 for 5G and/or NR operations in addition to any other standards operations at the time of this application.

The LMF 200 (NR/5G Node B, an evolved NB, or LTE device) is a network node such as a node including a location management function device (e.g., for NR or LTE long term evolution) that communicates with devices such the sender device 170 and receiver device 110 of FIG. 12. The LMF 12 provides access to wireless devices such as the UE 10 to the wireless network 1. The LMF 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 221 with the receiver device 110. The one or more memories MEM 12B and the computer program code PROG 12C are configured to cause, with the one or more processors DP 12A, the LMF 12 to perform one or more of the operations as described herein. The LMF 12 may communicate with the gNB or eNB 170 such as via link 225 and 131. Further, the link 221, 225, or 131 and/or any other link may be wired or wireless or both and may implement, e.g., an X2 or Xn interface. Further the link 221, 225, or 131 and may be through other network devices such as, but not limited to an NCE/MME/SGW/UDM/PCF/AMF/SMF/LMF 14 device as in FIG. 13. The LMF 12 may perform functionalities of an MME (Mobility Management Entity) or SGW (Serving Gateway), such as a User Plane Functionality, and/or an Access Management functionality for LTE and similar functionality for 5G.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions and other functions as described herein to control a network device such as the receiver device 110, sender device 170, and/or NCE/MME/SGW 190 as in FIG. 12.

It is noted that functionality(ies), in accordance with example embodiments of the invention, of any devices as shown in FIG. 12, e.g., the receiver device 110 and/or sender device 170 can also be implemented by other network nodes, e.g., a wireless or wired relay node (a.k.a., integrated access and/or backhaul (IAB) node). In the IAB case, UE functionalities may be carried out by MT (mobile termination) part of the IAB node, and gNB functionalities by DU (Data Unit) part of the IAB node, respectively. These devices can be linked to the receiver device 110 as in FIG. 12 at least via the wireless link 111 and/or via the NCE/MME/SGW 190 using link 199 to Other Network(s)/Internet as in FIG. 12.

As similarly stated above, example embodiments of the invention relate to a gradual decoding refresh technique, in which a refresh area starts at any location of GDR/recovering picture and gradually expands over associated recovering pictures.

A non-transitory computer-readable medium (Memory(ies) 155 as in FIG. 12) storing program code (Computer Program Code 153 and/or the encoding and/or decoding module 150-2 as in FIG. 12), the program code executed by at least one processor (Processor(s) 152 and/or the encoding and/or decoding module 150-1 as in FIG. 12) to perform the operations as at least described in the paragraphs above.

In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 12) an area in a gradual decoding refresh (GDR) or recovering (GDR/recovering) picture; means for defining (Memory(ies) 125, 155; Computer Program Code 123, 153; encoding/decoding module 140-1, 150-1; and Processor(s) 120, 152 as in FIG. 12) one or more virtual boundaries for the GDR/recovering picture, wherein the one or more virtual boundaries separate the GDR/recovering picture into two or more areas; means for associating (Memory(ies) 125, 155; Computer Program Code 123, 153; encoding/decoding module 140-1, 150-1; and Processor(s) 120, 152 as in FIG. 12) a flag with each of the one or more virtual boundaries, wherein the flag specifies at least one of which side of the associated virtual boundary is in a refreshed area or which side is in a non-refreshed area; and means for encoding and signaling (One or more antennas/Remote radio head 128, 195; Memory(ies) 125, 155; Computer Program Code 123, 153 the flag to a decoder.

In an example embodiment to the paragraph above, wherein at least the means for determining, defining, associating, and encoding and signaling comprises a non-transitory computer readable medium [One or more antennas/Remote radio head 128, 195; Memory(ies) 125, 155 as in FIG. 12] encoded with a computer program [Computer Program Code 123, 153 and/or the encoding/decoding module 140-1, 150-2 as in FIG. 12] executable by at least one processor [Processor(s) 120, 152 as in FIG. 12].

A non-transitory computer-readable medium (Memory(ies) 125, 155 as in FIG. 12) storing program code (Computer Program Code 123, 153 and/or the encoding/decoding Module 140-1, 150-2 as in FIG. 12), the program code executed by at least one processor (Processor(s) 120, 152) to perform the operations as at least described in the paragraphs above.

In accordance with an example embodiments as described above there is an apparatus comprising: means for receiving (One or more antennas/Remote radio head 128, 195; Memory(ies) 125, 155; Computer Program Code 123, 153; encoding/decoding module 140-1, 150-1; and Processor(s) 120, 152 as in FIG. 12) a gradual decoding refresh (GDR) or recovering (GDR/recovering) picture, wherein the GDR/recovering picture comprises one or more virtual boundaries, wherein the one or more virtual boundaries separate the GDR/recovering picture into two or more areas; means for receiving (One or more antennas/Remote radio head 128, 195; Memory(ies) 125, 155; Computer Program Code 123, 153; encoding/decoding module 140-1, 150-1; and Processor(s) 120, 152 as in FIG. 12) a flag associated with each of the one or more virtual boundaries, wherein the flag specifies at least one of which side of each of the one or more virtual boundaries is in a refreshed area or which side in a non-refreshed area; and means for decoding (Memory(ies) 125, 155; Computer Program Code 123, 153; encoding/decoding module 140-1, 150-1; and Processor(s) 120, 152 as in FIG. 12) the GDR/recovering picture based on the one or more virtual boundaries and associated flags.

In an example embodiment to the paragraph above, wherein at least the means for receiving and decoding comprises a non-transitory computer readable medium [One or more antennas/Remote radio head 128, 195; Memory(ies) 125, 155 as in FIG. 12] encoded with a computer program [Computer Program Code 123, 153 and/or the encoding/decoding module 140-1, 150-2 as in FIG. 12] executable by at least one processor [Processor(s) 120, 152 as in FIG. 12].

A non-transitory computer-readable medium (Memory(ies) 125, 155 as in FIG. 12) storing program code (Computer Program Code 123, 153 and/or the encoding/decoding Module 140-1, 150-2 as in FIG. 12), the program code executed by at least one processor (Processor(s) 120, 152) are caused to perform the operations as at least described in the paragraphs above.

In accordance with an example embodiments as described above there is an apparatus comprising: means for using (Memory(ies) 125, 155; Computer Program Code 123, 153; encoding/decoding module 140-1, 150-1; and Processor(s) 120, 152 as in FIG. 12) a general gradual decoding refresh (GDR) technique, in which a refreshed area starts at any location in a gradual decoding refresh (GDR) picture and gradually expands over associated recovering picture.

In an example embodiment to the paragraph above, wherein at least the means for using comprises a non-transitory computer readable medium [One or more antennas/Remote radio head 128, 195; Memory(ies) 125, 155 as in FIG. 12] encoded with a computer program [Computer Program Code 123, 153 and/or the encoding/decoding module 140-1, 150-2 as in FIG. 12] executable by at least one processor [Processor(s) 120, 152 as in FIG. 12].

A non-transitory computer-readable medium (Memory(ies) 125, 155 as in FIG. 12) storing program code (Computer Program Code 123, 153 and/or the encoding/decoding Module 140-1, 150-2 as in FIG. 12), the program code executed by at least one processor (Processor(s) 120, 152) are caused to perform the operations as at least described in the paragraphs above.

In accordance with an example embodiments as described above there is an apparatus comprising: means for receiving (One or more antennas/Remote radio head 128, 195; Memory(ies) 125, 155; Computer Program Code 123, 153; encoding/decoding module 140-1, 150-1; and Processor(s) 120, 152 as in FIG. 12) a gradual decoding refresh (GDR) or recovering (GDR/recovering) picture, wherein a refreshed area starts at any location in the gradual decoding refresh (GDR) picture and expands over the recovering picture.

In an example embodiment to the paragraph above, wherein at least the means for receiving comprises a non-transitory computer readable medium [One or more antennas/Remote radio head 128, 195; Memory(ies) 125, 155 as in FIG. 12] encoded with a computer program [Computer Program Code 123, 153 and/or the encoding/decoding module 140-1, 150-2 as in FIG. 12] executable by at least one processor [Processor(s) 120, 152 as in FIG. 12].

A non-transitory computer-readable medium (Memory(ies) 125, 155 as in FIG. 12) storing program code (Computer Program Code 123, 153 and/or the encoding/decoding Module 140-1, 150-2 as in FIG. 12), the program code executed by at least one processor (Processor(s) 120, 152) are caused to perform the operations as at least described in the paragraphs above.

Further, in accordance with example embodiments of the invention there is circuitry for performing operations in accordance with example embodiments of the invention as disclosed herein. This circuitry may include any type of circuitry including content coding circuitry, content decoding circuitry, processing circuitry, image generation circuitry, data analysis circuitry, and the like.). Further, this circuitry may include discrete circuitry, application-specific integrated circuitry (ASIC), and/or field-programmable gate array circuitry (FPGA), and the like. as well as a processor specifically configured by software to perform the respective function, or dual-core processors with software and corresponding digital signal processors, and the like.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments as disclosed in this application this application, the “circuitry” provided may include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In general, the various embodiments may be implemented in hardware or special purpose circuits, software, logic or any combination thereof. For example, some features may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

In some embodiments, certain ones of the operations above may be modified or further amplified. Furthermore, in some embodiments, additional optional operations may be included. Modifications, additions, or amplifications to the operations above may be performed in any order and in any combination.

Though, some example embodiments have been described with the help of gradual decoding refresh and gradual decoding refresh picture(s), it needs to be understood, however, that the embodiments are also applicable to other refresh decoding techniques and recovering pictures. Further, the embodiments may have been described with help of the central area of the recovering picture as start of the refreshed area, it needs to be understood, however the embodiments are also applicable to scenarios where the start of the refreshed area is any other location in the recovering picture.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the embodiments of this invention could be used to advantage without the corresponding use of other features. As such, the foregoing description should be considered as merely illustrative of the principles of the invention, and not in limitation thereof.

1-25. (canceled)

26. A method comprising:
using a general gradual decoding refresh (GDR) technique, in which a refreshed area starts at any location in a gradual decoding refresh (GDR) picture and gradually expands over associated recovering picture.

27. The method of claim 26 further comprising:
determining an area in the gradual decoding refresh (GDR) or recovering (GDR/recovering) picture;
defining one or more virtual boundaries for the GDR/recovering picture, wherein the one or more virtual boundaries separate the GDR/recovering picture into two or more areas;
associating an indication message or information with each of the one or more virtual boundaries, wherein the indication message or information specifies at least one of which side of an associated virtual boundary is in a refreshed area or which side is in a non-refreshed area; and
encoding and signaling the indication message or information to a decoder.

28. A method comprising:
receiving a gradual decoding refresh (GDR) or recovering (GDR/recovering) picture, wherein a refreshed area starts at any location in the gradual decoding refresh (GDR) picture and expands over the recovering picture.

29. The method of claim 28, wherein the GDR/recovering picture comprises one or more virtual boundaries, wherein the one or more virtual boundaries separate the GDR/recovering picture into two or more areas, and wherein the method further comprises:
receiving an indication message or information associated with each of the one or more virtual boundaries, wherein the indication message or information specifies at least one of which side of each of the one or more virtual boundaries is in the refreshed area or which side is in a non-refreshed area; and
decoding the GDR/recovering picture based on the one or more virtual boundaries and an associated indication message or information.

30. The method of claim 29, wherein when the indication message or information is equal to one specifies position or location of the refreshed area with respect to the virtual boundary associated with the indication message or information.

31. The method of claim 29, wherein when the indication message or information is equal to zero specifies position or location of a non-refreshed area with respect to the virtual boundary associated with the indication message or information.

32. The method of claim 29, wherein the one or more virtual boundaries comprise one or more vertical virtual boundaries and/or one or more horizontal virtual boundaries.

33. The method of claim 32, wherein when the indication message or information is equal to one and is associated with a vertical virtual boundary, the indication message or information specifies that an area on left of the vertical virtual boundary is the refreshed area and the area on the right of the vertical virtual boundary is the non-refreshed area; or wherein when the indication message or information is equal to one and is associated with a horizontal virtual boundary, the indication message or information specifies that the area above the horizontal virtual boundary is the refreshed area and the area below the horizontal virtual boundary is the non-refreshed area.

34. The method of claim 32, wherein when the indication message or information is equal to zero and is associated with a vertical virtual boundary, the indication message or information specifies that an area on left of the vertical virtual boundary is the non-refreshed area and the area on right of the vertical virtual boundary is the refreshed area; or wherein when the indication message or information is equal to zero and is associated with a horizontal virtual boundary, the indication message or information specifies that the area above the horizontal virtual boundary is the non-refreshed area and the area below the horizontal virtual boundary is the refreshed area.

35. An apparatus comprising:
at least one processor; and
at least one memory storing instructions that, when executed by the at least one processor, cause the apparatus at least to perform:
using a general gradual decoding refresh (GDR) technique, in which a refreshed area starts at any location in a gradual decoding refresh (GDR) picture and gradually expands over associated recovering picture.

36. The apparatus of claim 35, wherein the apparatus is further caused to
perform:
determining an area in a gradual decoding refresh (GDR) or recovering (GDR/recovering) picture;
defining one or more virtual boundaries for the GDR/recovering picture, wherein the one or more virtual boundaries separate the GDR/recovering picture into two or more areas;
associating an indication message or information with each of the one or more virtual boundaries, wherein the indication message or information specifies at least one of which side of an associated virtual boundary is in a refreshed area or which side is in a non-refreshed area; and
encoding and signaling the indication message or information to a decoder.

37. An apparatus comprising:
at least one processor; and
at least one memory storing instructions that, when executed by the at least one processor, cause the apparatus at least to perform:
receiving a gradual decoding refresh (GDR) or recovering (GDR/recovering) picture, wherein a refreshed area starts at any location in the gradual decoding refresh (GDR) picture and expands over the recovering picture.

38. The apparatus of claim 37, wherein the GDR/recovering picture comprises one or more virtual boundaries, wherein the one or more virtual boundaries separate the GDR/recovering picture into two or more areas, and wherein the apparatus is further caused to perform:
receiving an indication message or information associated with each of the one or more virtual boundaries, wherein the indication message or information specifies at least one of which side of each of the one or more virtual boundaries is in the refreshed area or which side is in a non-refreshed area; and
decoding the GDR/recovering picture based on the one or more virtual boundaries and associated indication message or information.

39. The apparatus of claim 38, wherein when the indication message or information is equal to one specifies position or location of the refreshed area with respect to the virtual boundary associated with the indication message or information.

40. The apparatus of claim 38, wherein when the indication message or information is equal to zero specifies position or location of a non-refreshed area with respect to the virtual boundary associated with the indication message or information.

41. The apparatus of claim 38, wherein the one or more virtual boundaries comprise one or more vertical virtual boundaries and/or one or more horizontal virtual boundaries.

42. The apparatus of claim 41, wherein when the indication message or information is equal to one and is associated with a vertical virtual boundary, the indication message or information specifies that an area on left of the vertical virtual boundary is the refreshed area and the area on the right of the vertical virtual boundary is the non-refreshed area.

43. The apparatus of claim 41, wherein when the indication message or information is equal to one and is associated with a horizontal virtual boundary, the indication message or information specifies that an area above the horizontal virtual boundary is the refreshed area and the area below the horizontal virtual boundary is the non-refreshed area.

44. The apparatus of claim 41, wherein when the indication message or information is equal to zero and is associated with a vertical virtual boundary, the indication message or information specifies that an area on left of the vertical virtual boundary is the non-refreshed area and the area on right of the vertical virtual boundary is the refreshed area.

45. The apparatus of claim 41, wherein when the indication message or information is equal to zero and is associated with a horizontal virtual boundary, the indication message or information specifies that an area above the horizontal virtual boundary is the non-refreshed area and the area below the horizontal virtual boundary is the refreshed area.
